(19) United States
(12) Patent Application Publication
(10) Pub. No.: US 2003/0056837 A1
(43) Pub. Date: Mar. 27, 2003

(54) Controlling fuel tank vapor venting during refueling

(75) Inventor: Robert P. Benjey, Dexter, MI (US)

Correspondence Address: EATON CORPORATION, EATON CENTER, 1111 SUPERIOR AVENUE, CLEVELAND, OH, 44114

(73) Assignee: EATON CORPORATION, Cleveland, OH

(21) Appl. No.: 09/963,815

(22) Filed: Sep. 26, 2001

(51) Int. Cl. F02M 33/08

(52) U.S. Cl. 137/587

(57) ABSTRACT

A fuel tank vapor vent system for a motor vehicle having a float operated vent valve in the tank top for permitting fuel vapor flow through a vapor conduit to a remote storage canister. A filler nozzle seal in the tank filler neck seals about the nozzle during refueling. A recirculation line is connected to the filler neck below the nozzle seal and also to the vapor conduit to the canister. Fuel flow in the filler neck during refueling effects recirculation of some of the vapor flowing to the canister and minimizes the size of canister required.

### BACKGROUND OF THE INVENTION

The present invention relates to systems for providing controlled venting and preventing escape to the atmosphere of fuel vapor from a fuel tank, particularly on board a motor vehicle, and more particularly during refueling.

Currently, production motor vehicles operating on gasoline or other highly volatile fuel, employ a storage unit, typically a remotely located canister charged with charcoal, connected to receive fuel vapor from a float operated vent valve provided on the fuel tank. During periods of engine shutdown vapor is adsorbed in the canister and stored. Upon startup of the engine, the canister is purged by air and the fuel vapors are drawn from the canister into the engine inlet and comprise a portion of the engine combustion charge.

When the engine is not operating, the canister must absorb all of the vapor from the fuel tank which is either displaced from the tank through vent valve by the rising fuel level during refueling, or from the tank when the vapor pressure rises above atmospheric.

When the fuel tank filler neck is open for refueling by insertion of a fuel filler nozzle, and fuel is flowing from the nozzle into the filler neck, it is desired to prevent escape of the fuel vapor from the tank through the filler neck and thus bypassing the vent valve to the storage canister. Heretofore, this problem has been addressed by providing a mechanical seal in the filler neck for sealing about the filler nozzle. In such an arrangement a recirculation line has been connected from the fuel tank upper wall to the filler neck below the nozzle seal.

Referring to FIGS. 3 and 4, a known system of the above-described type is illustrated and has the fuel tank 1 with a filler neck 2 receiving fuel during refueling by a filler nozzle 3 inserted into the upper end 2a of the filler neck through a seal 4 and sufficiently further to open a one-way flapper valve 5 and permit the nozzle to discharge into the filler neck 2.

A pressure relief valve 6 is provided in the filler neck upper end 2a and serves as a bypass for the seal 4 in the event of a failure of the aspirator controlled automatic shutoff in the refueling nozzle 3.

A float operated vent valve 7 is received through an aperture in the upper wall of the tank and has a flange 8 registering against the exterior of the upper tank wall; and, the valve flange is secured to the upper tank wall. The valve 7 has its outlet connected to a vapor vent conduit 9 which is connected to a storage canister 10 which has an outlet line 11 adapted for connection to an engine air inlet (not shown). Typically, the canister 10 has an atmospheric purge air inlet 12 for permitting air to be drawn in the canister upon engine startup and creation of a vacuum in the line 11. Vacuum in the canister is created by the flow restriction of the granular fill in the canister.

Air leakage past the mechanical seal 4 in the tube around the refueling nozzle causes increased vaporization of fuel in the tank and the canister is subjected to increased vapor flow from the tank. This results in the requirement for additional canister capacity.

A recirculation line 13 has one end connected to the upper end of filler neck 2a below the seal 4. The remaining end of the conduit 13 is connected to the upper wall of the tank 1 and extends to a desired liquid fill level within the tank and is closed by the rising level of the fuel in the tank as indicated generally by reference numeral 14 in FIG. 3.

The system of FIGS. 3 and 4 permits fuel vapor to be recirculated through the filler nozzle until the fuel level 14 closes off the end of the tube 13 within the tank. Closure of tube 13 causes continued fuel flow through the nozzle to create a vacuum within upper tube 2a below seal 4, which vacuum starves the nozzle aspirator and effects nozzle shutoff.

Referring to FIG. 5, another system of the prior art is illustrated pictorially where a fuel tank 1 a has a filler tube 4a with an enlarged cup-shaped upper end portion 5a shown with refueling nozzle 3a received therein and having the end thereof inserted in closely fitting arrangement in the upper end of the filler tube 4a. The lower end of the filler tube 4a extends into the fuel tank and has a one-way valve 6a provided thereon to permit fuel to enter the tank but not filler neck 4a. The tank has a float operated vent valve 7a provided in the top thereof and registered thereagainst by flange 8a with the valve 7a extending through an access opening into the tank for sensing the fuel level indicated generally at 14a.

Valve 7a has conduit 9a connected thereto and to storage canister 10a which is vented through the atmospheric air inlet tube 12a. Canister 10a has a purge line 11 a connected thereto and adapted for connection to the air (not shown) of the vehicle engine. Tube 9a is also connected through conduit 13a to the enlarged upper end 5a of the filler neck for recirculating fuel vapor thereto. During filling, the aspirating effects of the liquid fuel flow from the nozzle creates a reduced pressure in the upper end of the tube 5a and draws in air and vapor from 13a into the filler tube 4a and the tank. The air drawn in further increases fuel vaporization. Flow of fuel vapor to the atmosphere through tube 13a can occur if 13a vapor flow is not significantly limited.

### BRIEF SUMMARY OF THE INVENTION

The present invention provides a solution to the above-described problem of minimizing the vapor storage capacity of a fuel vapor storage canister in a fuel vapor vent control system particularly for a motor vehicle and more particularly during refueling operations.

The system of the present invention employs a float operated vent valve mounted in the top of the fuel tank with the vent valve outlet connected through a vent line to a storage canister which is adapted for purging and vapor flow into the air inlet of an engine upon engine startup. In the present system, the filler neck of the tank has the upper end enlarged to receive a fuel filler nozzle therein and includes a seal for sealing about the nozzle upon insertion. A recirculation line is connected from the filler neck at a location downstream of the nozzle seal to the vapor line connected to the canister. Thus, during refueling some of the vapor flowing through the float operated vent valve to the canister is recirculated to the fuel filler neck to facilitate flow of the liquid fuel into the tank and minimize the flow to the canister, thereby reducing the quantity of the fuel flow to storage canister during refueling.

### BRIEF DESCRIPTION OF THE DRAWINGS

FIG. 1 is a pictorial schematic of the invention fuel vapor vent system for a motor vehicle fuel tank during refueling;

FIG. 2 is an enlarged view of a portion of FIG. 1;

FIG. 3 is a view similar to FIG. 1 for a prior art system;

FIG. 4 is an enlarged view of a portion of FIG. 3; and,

FIG. 5 is a pictorial schematic of another prior art system.

### DETAILED DESCRIPTION OF THE INVENTION

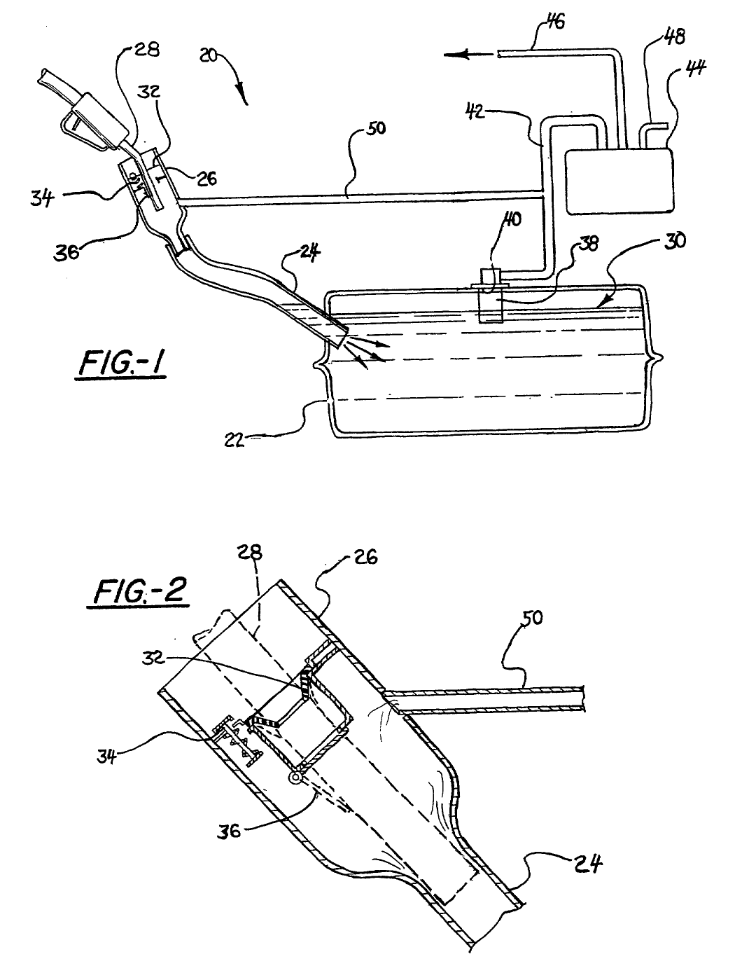

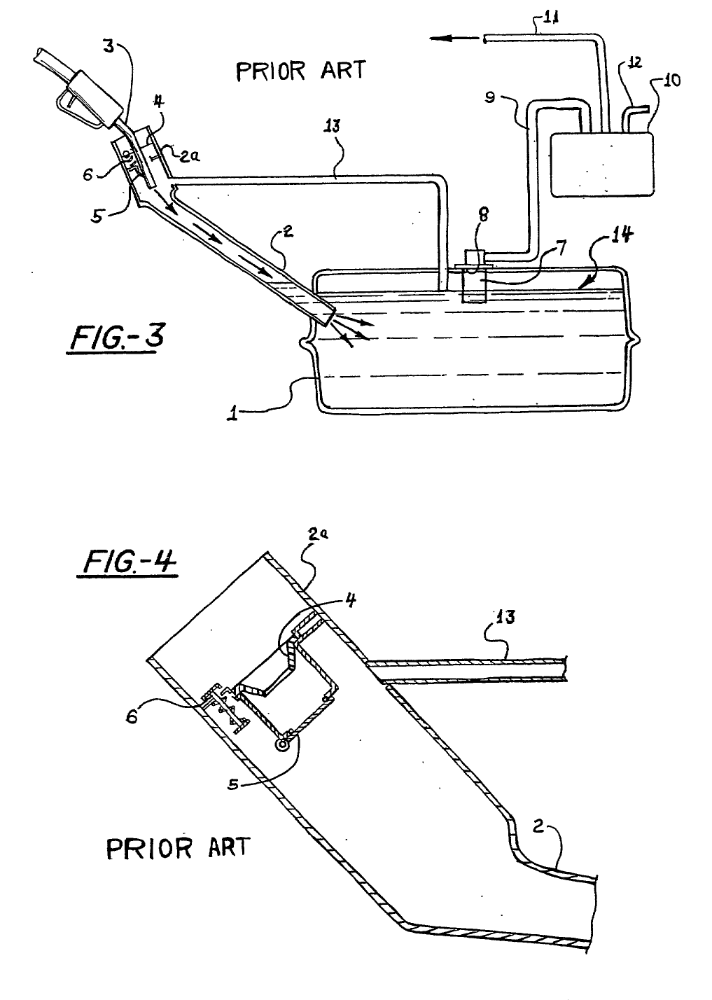

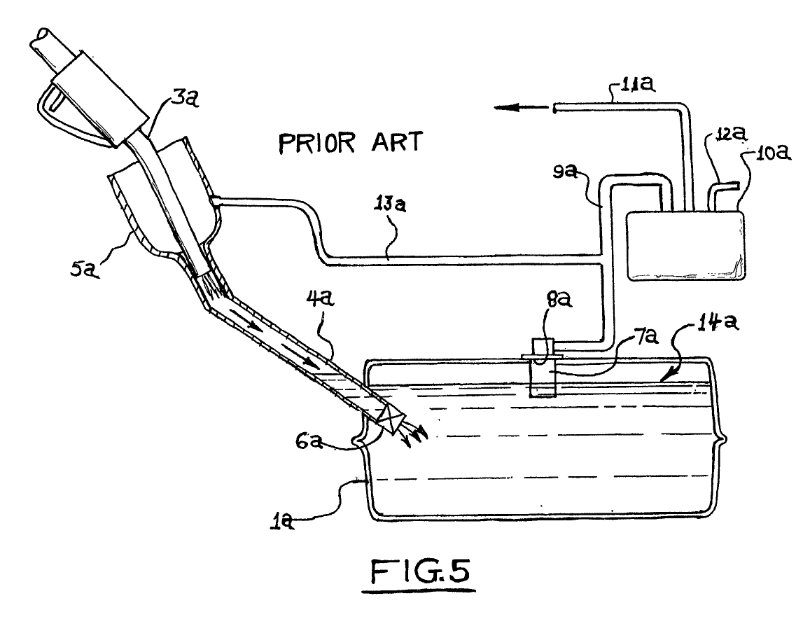

Referring to FIGS. 1 and 2, the system of the present invention is indicated generally at 20 and includes a vehicle fuel tank 22 having a filler neck 24 attached thereto with an enlarged upper end 26 with a refueling filler nozzle 28 received therein for providing flow of fuel indicated by the black arrows into the interior of the tank. The fuel level in the tank is indicated generally at 30. The enlarged portion of the filler neck 26 has disposed therein a mechanical seal 32 which seals about the outer periphery of the nozzle 28 and preferably includes an annular member of elastomeric material as shown in FIG. 2.

The enlarged portion of the filler neck 26 also has a pressure relief valve 34 disposed therein for providing bypass of the seal 32 in the event of nozzle shutoff failure and excessive fuel pressure buildup within the filler neck. Below the seal 32 is disposed an optional one-way flapper valve 36 which is opened by the nozzle 28 upon insertion through the seal 32 as shown in dashed outline in FIG. 2.

The tank 22 has a float operated vent valve 38 disposed in the top wall thereof through an access opening and has a flange 40 thereon registered against the exterior surface of the tank top for attachment thereto and sealing there around in a manner well known in the art. The outlet of the valve 40 is connected through a conduit 42 to the inlet of a vapor storage canister 44 which has a purge line 46 connected thereto which is adapted for connection to the air inlet of an engine (not shown) for enabling flow of vapor therethrough upon engine startup. An atmospheric air inlet 48 is provided in the canister to provide purge flow of air into the canister upon engine startup.

A vapor recirculation line 50 has one end connected to the upper end 26 of the filler neck in a region below or downstream of the mechanical seal 32; and, the opposite end of the line 50 is connected into the vapor purge line 42 for providing recirculation of a portion of the vapor flowing through the line 42. This recirculation is facilitated by the aspiration effect of the flow of the fuel in the filler neck 24 during refueling.

Upon insertion of the filler nozzle 28 into the filler tube upper end 26 and, smaller diameter neck 24, and upon discharge of fuel from nozzle 28, a liquid seal is created between nozzle 28 and the inner periphery of neck 28. This liquid seal entrains recirculated vapor from tube 50 into the tank. It will be understood that the recirculated vapor in tube 50 replaces the amount of air entering the filler neck 24 except for leakage past the mechanical seal 32.

Upon removal of the nozzle and closure of the flapper valve 36, and during engine operation, fuel vapor venting from the tank is through valve 38 and conduit 42 to the canister 44. With the nozzle removed there is no flow-induced recirculation through the conduit 50.

The present invention thus provides a conduit from the canister vent line for recirculation through the filler neck fuel vapors in the tank during refueling and provides a mechanical seal above the recirculation conduit and a liquid seal in the filler neck upon insertion of a refueling nozzle and fuel flow into the filler neck. The system of the invention minimizes the flow to the storage canister during refueling and thus reduces the quantity of vapor the canister must store and permits reducing the canister adsorbent fill and overall canister volume.

Although the invention has hereinabove been described with respect to the illustrated embodiments, it will be understood that the invention is capable of modification and variation and is limited only by the following claims.

What is claimed is:

1. A method of controlling fuel tank vapor venting during refueling comprising:
(a) providing a fuel filler neck on the tank and inserting a fuel filler nozzle in the tank filler neck and mechanically sealing between the nozzle and filler neck;
(b) disposing a vent valve in the upper wall of the tank and connecting a vapor vent line from the vent valve to a vapor storage canister; and,
(c) connecting one end of a recirculation line to the filler neck downstream of the mechanical seal and connecting an end opposite the one end to the vapor vent line and recirculating tank vapor during refueling; and, forming a liquid seal between the filler neck and the fuel discharged from the nozzle during refueling.

2. The method defined in claim 1, wherein said step of disposing a vent valve includes disposing a float operated valve.

3. The method defined in claim 1, wherein said step of providing a fuel filler neck includes providing a relief valve for bypassing the mechanical sealing.

4. In a tank refueling vapor control system of the type having a vapor storage canister, and seal for a refueling nozzle in the tank filler tube, the improvement comprising:
(a) a vent valve disposed on the tank upper wall and having a vapor vent line therefrom connected to the canister;
(b) a recirculation line having one end connected to the filler neck downstream of the nozzle seal and the end opposite the one end connected to the vent line for recirculating vapor during refueling.

5. The improvement defined in claim 4, wherein the vent valve is float operated.

6. The improvement defined in claim 4, wherein the filler neck includes a pressure relief valve for bypassing the nozzle seal in the event of excessive fuel vapor pressure.

7. The improvement defined in claim 4, wherein the filler neck includes a one-way valve disposed downstream of the mechanical seal and adapted to be opened by insertion of a refueling nozzle.

8. A method of controlling fuel tank vapor venting during refueling comprising:
(a) providing a fuel filler neck in the tank;
(b) sealing about a fuel filler nozzle upon insertion in the filler neck;
(c) venting tank vapor through a valve and connecting the valve outlet to a storage canister; and,
(d) recirculating vapor from the valve outlet to the filler neck; and, forming a liquid seal between the filler neck and the fuel discharged from the nozzle during refueling.

9. The method defined in claim 8, wherein said step of recirculating includes connecting one end of a vapor vent line to the valve outlet and an end opposite said one end of said vapor vent line to the canister; and, connecting one end of a recirculation line to said vapor vent line and an end opposite said one end of said recirculation line to the filler neck.

10. The method defined in claim 8, wherein said step of venting tank vapor through a valve includes operating the valve with a float.

11. The method defined in claim 8, wherein said step of sealing about a filler nozzle includes disposing a seal in the filler neck and providing a pressure relief valve for bypassing said seal in the event of excessive fuel vapor pressure in the tank.
